(19) United States
(12) Patent Application Publication
(10) Pub. No.: US 2012/0007951 A1
(43) Pub. Date: Jan. 12, 2012

(54) SYSTEM AND FORMAT FOR ENCODING DATA AND THREE-DIMENSIONAL RENDERING

(75) Inventor: Alain Fogel, Zorneding (DE)

(73) Assignee: NOMAD3D SAS, NICE (FR)

(21) Appl. No.: 13/258,460

(22) PCT Filed: Mar. 25, 2010
(86) PCT No.: PCT/IB10/51311

§ 371 Date: Sep. 22, 2011

Related U.S. Application Data
(60) Provisional application No. 61/238,697, filed on Sep. 1, 2009.
(60) Provisional application No. 61/164,431, filed on Mar. 29, 2009.

(51) Int. Cl. H04N 13/00

(52) U.S. Cl. 348/43; 348/E13.062

(57) ABSTRACT

3D+F encoding of data and three-dimensional rendering includes generating a fused view 2D image and associated generating-vectors, by combining first and second 2D images such that the fused view 2D image contains information associated with elements of the first and second 2D images, and the generating-vectors indicate operations to be performed on the elements of the fused view 2D image to recover the first and second 2D images. The facilitates 3D rendering using reduced power requirements compared to conventional techniques, while providing high quality, industry standard image quality.

### FIELD OF THE INVENTION

The present embodiment generally relates to the field of computer vision and graphics, and in particular, it concerns a system and format for three-dimensional encoding and rendering, especially applicable to mobile devices.

### BACKGROUND OF THE INVENTION

Three-dimensional (3D) stereovision imaging technology can be described as the next revolution in modern video technology. Stereovision is visual perception in three dimensions, particularly capturing two separate images of a scene and combining the images into a 3D perception of the scene. The idea of stereovision, as the basis for 3D viewing, has origins in the 1800′s, but has so far not been widely used because of technological barriers. From one point of view, the current plethora of two-dimensional (2D) imaging technology is seen as a compromise to 3D imaging. A large amount of research and development is currently focused on 3D imaging. Recent advances include:
3D stereoscopic LCD displays enabling users to view stereo and multiview images in 3D without the user wearing glasses.
3D movie theaters are becoming more common (Pixar, Disney 3-D and IMAX).
Plans for increased television broadcasting of 3D programs (for example ESPN currently plans to broadcast the 2010 World Cup in 3D).
3D movies (for example, Avatar) are enjoying an exceptional popular success.

Many fields and applications plan to incorporate 3D imaging. Predications are that large consumer markets include 3D television, 3D Smartphones, and 3D tablets. Currently, high definition (HD) television (HDTV) is the standard for video quality. HD Smartphones with impressive LCD resolution (720p) are appearing on the mobile market. 3D imaging will bring a new dimension to HD.

In the context of this document, 3D stereovision imaging, 3D stereovision, and 3D imaging are used interchangeably, unless specified otherwise. 3D stereovision includes a basic problem of doubling the quantity of content information compared to 2D imaging, which translates into doubling the storage and transmission bandwidth requirements. Therefore, methods are being developed for the purpose of reducing the information required for 3D imaging, preferably by a factor that is significantly less than 2.

Referring to FIG. 1, a diagram of a general 3D content and technology chain, source 3D imaging information, commonly referred to as content, or 3D content (for example, a 3D movie), is created 100 by content providers 110. Reducing the 3D information is done in an encoding stage, (in this case a 3D encoding stage) 102 by algorithms generally known as encoding algorithms. The goal of 3D encoding algorithms is to transform a given amount of source 3D imaging information in a source format into a reduced amount of information in an encoded format, also referred to as an image format. In the context of this document, 3D content that has been encoded is generally referred to as encoded information.

Encoding is typically done before transmission, generally performed off-line in an application server 112. Popular examples include Itunes and YouTube performing encoding of content for storage, allowing the stored encoded information to be transmitted on-demand.

After transmission 104 (for example, by a fourth generation “4G” wireless communications standard), by a communications service provider (in this diagram shown as cellular operators) 114, the encoded information needs to be decoded by a receiving device 120 and rendered for display. Receiving devices 120 are also generally referred to as user devices, or client devices. Decoding includes transforming encoded information from an encoded format to a format suitable for rendering. Rendering includes generating from the decoded information sufficient information for the 3D content to be viewed on a display. For 3D stereovision, two views need to be generated, generally referred to as a left view and a right view, respectively associated with the left and right eyes of a user. As detailed below, decoding and rendering 106 are conventionally implemented by cell phone manufacturers 116 in an application processor in a cell phone. Depending on the encoded format, application, and receiving device, decoding and rendering can be done in separate stages or in some degree of combination. To implement stereovision, both left and right views of the original 3D content must be rendered and sent to be displayed 108 for viewing by a user. Displays are typically provided by display manufacturers 118 and integrated into user devices.

The most popular rendering techniques currently developed are based on the 2D+Depth image format, which is promoted in the MPEG forum. The basic principle of a 2D+Depth image format is a combination of a 2D-image of a first view (for example, a right view) and a depth image. Decoding a 2D+Depth image format requires complex algorithms (and associated high power requirements) on the receiving device to generate a second view (for example, a left view) from a first view (for example, a right view).

Conventional 2D and 2D+Depth formats are now described to provide background and a reference for 3D imaging architecture, encoding, format, decoding, rendering, and display. Referring again to FIG. 1, the 2D+Depth format primarily requires implementation at the encoding stage 102 and the decoding and rendering stage 106. As stated above, the basic principle of a 2D+Depth image format is a combination of a 2D-image of a first view and a depth image. The 2D-image is typically one of the views (for example, the left view or right view) or a view close to one of the views (for example, a center view). This 2D image can be viewed without using the depth map and will show a normal 2D view of the content.

Referring to FIG. 2A, a 2D-image of a center view of objects in three dimensions, objects 200, 202, and 204 are respectively farther away from a viewer. Referring to FIG. 2B, a simplified depth image, the depths (distances) from the viewer to the objects are provided as a grayscale image. The shades of gray of objects 210, 212, and 214 represent the depth of the associated points, indicated in the diagram by different hashing.

Referring to FIG. 3, a diagram of a typical 2D architecture, a cell phone architecture is used as an example for the process flow of video playback (also applicable to streaming video) on a user device, to help clarify this explanation. Encoded information, in this case compressed video packets, are read from a memory card 300 by a video decoder 302 (also known as a video hardware engine) in an application processor 304 and sent via an external bus interface 306 to video decoder memory 308 (commonly dedicated memory external to the application processor). The encoded information (video packets) is decoded by video decoder 302 to generate decoded frames that are sent to a display interface 310. Decoding typically includes decompression. In a case where the video packets are 1.264 format, the video decoder 302 is a H.264 decoder and reads packets from the previous frame that were stored in memory 308 (which in this case includes configuration as a double frame buffer) in order to generate a new frame using the delta data (information on the difference between the previous frame and the current frame). 11.264 decoded frames are also sent to memory 308 for storage in the double frame buffer, for use in decoding the subsequent encoded packet.

Decoded frames are sent (for example via a MITI DSI interface) from the display interface 310 in the application processor 304 via a display system interface 312 in a display system 322 to a display controller 314 (in this case an LCD controller), which stores the decoded frames in a display memory 320. From display memory 320, the LCD controller 314 sends the decoded frames via a display driver 316 to a display 318. Display 318 is configured as appropriate for the specific device and application to present the decoded frames to a user, allowing the user to view the desired content.

Optionally, the 2D architecture may include a service provider communication module 330, which in the case of a cellular phone provides a radio frequency (RF) front end for cellular phone service. Optionally, user communication modules 332 can provide local communication for the user, for example Bluetooth or Wi-Fi. Both service provider and user communications can be used to provide content to a user device.

Referring to FIG. 4, a diagram of a typical 2D+Depth architecture for the process flow of video on a user device, a cell phone architecture is again used as an example. Generally, the processing flow for 2D+Depth is similar to the processing flow for 2D, with the significant differences of: More data needs to be processed and additional processing is required to generate both left and right views for stereovision imaging.

Encoded information is read from memory card 300, which in this case includes two 2D-images associated with every frame (as described above, one 2D-image is of a first view and one 2D-image is the depth image). The encoded information is decoded by video decoder and 3D rendering modeule 402 to generate decoded frames (decompression). In contrast to 2D playback where video decoder 302 (FIG. 3) performed decoding once, in the case of 2D+Depth playback, video decoder 402 needs to perform decoding twice for each frame: one decoding for the 2D-image and one decoding for the depth map. In a case where the video packets are H.264 format, the depth map is a compressed grayscale 2D-image and an additional double buffer is required in the video decoder and 3D rendering memory 408 for decoding the depth map. Memory 408 is commonly implemented as a dedicated memory external to the application processor, and in this case in about 1.5 times the size of memory 308. The video decoder 402 includes a hardware rendering machine (not shown) to process the decoded frames and render left and right views required for stereovision.

The rendered left and right views for each frame are sent from the display interface 310 in the application processor 304 via a display system interface 312 in a display system 322 to a display controller 314 (in this case an LCD controller). Note that in comparison to the above-described 2D playback, because twice as much data is being transmitted the communications channel requires higher bandwidth and power to operate. In addition, the LCD controller processes two views instead of one, which requires higher bandwidth and power. Each view is stored in a display memory 420, which can be twice the size of the comparable 2D display memory 320 (FIG. 3). From display memory 420, the LCD controller 314 sends the decoded frames via a display driver 316 to a 3D display 418. Power analysis has shown that 2D+Depth processing requires nominally 50% more power, twice as much bandwidth, and up to twice as much memory, as compared to 2D processing.

As can be seen from the descriptions of FIG. 3 and FIG. 4, upgrading a user device from 2D processing to 2D+Depth processing requires significant modifications in multiple portions of the device. In particular, new hardware, including additional memory and a new video decoder, and new executable code (generally referred to as software) are required on an application processor 304. This new hardware is necessary in order to try to minimize the increased power consumption of 2D+Depth.

Decoding a 2D+Depth image format requires complex algorithms (and associated high power requirements) on the receiving device to generate a second view (for example, a left view) from a first view (for example, a right view). Complex rendering algorithms can involve geometric computations, for example computing the disparities between left and right images that may be used for rendering the left and right views. Some portions of a rendered image are visible only from the right eye or only from the left eye. The portions of a first image that cannot be seen in a second image are said to be occluded. Hence, while the rendering process takes place, every pixel that is rendered must be tested for occlusion. On the other hand, pixels that are not visible in the 2D-image must be rendered from overhead information. This makes the rendering process complex and time consuming. In addition, depending on the content encoded in 2D+Depth, a large amount of overhead information may need to be transmitted with the encoded information.

As can be seen from the above-described conventional technique for 3D imaging, the architecture implementation requirements are significant for the receiving device. In particular, for a hand-held mobile device, for example, a Smartphone, a conventional 3D imaging architecture has a direct impact on the hardware complexity, device size, power consumption, and hardware cost (commonly referred to in the art as bill of material, BoM).

There is therefore a need for a system and format that facilitates 3D rendering on a user device using reduced power requirements compared to conventional techniques, while providing high quality, industry standard image quality. It is further desirable for the system to facilitate implementation with minimal hardware changes to conventional user devices, preferably facilitating implementation in existing 2D hardware architectures.

### SUMMARY

According to the teachings of the present embodiment there is provided a method for storing data including the steps of receiving a first set of data; receiving a second set of data; generating a fused set of data and associated generating-vectors, by combining the first and second sets of data, such that the fused set of data contains information associated with elements of the first and second sets of data, and the generating-vectors indicate operations to be performed on the elements of the fused set of data to recover the first and second sets of data; and storing the fused set of data and the generating-vectors in association with each other.

According to the teachings of the present embodiment there is provided a method for encoding data including the steps of: receiving a first two-dimensional (2D) image of a scene from a first viewing angle; receiving a second 2D image of the scene from a second viewing angle; generating a fused view 2D image and associated generating-vectors, by combining the first and second 2D images such that the fused view 2D image contains information associated with elements of the first and second 2D images, and the generating-vectors indicate operations to be performed on the elements of the fused view 2D image to recover the first and second 2D images; and storing the fused view 2D image and the generating-vectors in association with each other.

According to the teachings of the present embodiment there is provided a method for decoding data including the steps of: providing a fused view 2D image containing information associated with elements of a first 2D image and a second 2D image; providing generating-vectors associated with the fused 2D image, the generating-vectors indicating operations to be performed on the elements of the fused view 2D image to render the first and second 2D images; and rendering, using the fused view 2D image and the generating-vectors, at least the first 2D image.

In an optional embodiment, the method further includes the step of rendering the second 2D image.

According to the teachings of the present embodiment there is provided a system for storing data including: a processing system containing one or more processors, the processing system being configured to: receive a first set of data; receive a second set of data; generate a fused set of data and associated generating-vectors, by combining the first and second sets of data, such that the fused set of data contains information associated with elements of the first and second sets of data, and the generating-vectors indicate operations to be performed on the elements of the fused set of data to recover the first and second sets of data; and a storage module configured to store the fused set of data and the generating-vectors in association with each other.

In an optional embodiment, the system stores the data is in H.264 format.

According to the teachings of the present embodiment there is provided a system for encoding data including: a processing system containing one or more processors, the processing system being configured to: receive a first two-dimensional (2D) image of a scene from a first viewing angle; receive a second 2D image of the scene from a second viewing angle; generate a fused view 2D image and associated generating-vectors, by combining the first and second 2D images such that the fused view 2D image contains information associated with elements of the first and second 2D images, and the generating-vectors indicate operations to be performed on the elements of the fused view 2D image to recover the first and second 2D images; and storage module configured to store the fused view 2D image and the generating-vectors in association with each other.

According to the teachings of the present embodiment there is provided a system for decoding data including: a processing system containing one or more processors, the processing system being configured to: provide a fused view 2D image containing information associated with elements of a first 2D image and a second 2D image; provide generating-vectors associated with the fused 2D image, the generating-vectors indicating operations to be performed on the elements of the fused. view 2D image to render the first and second 2D images; and render, using the fused view 2D image and the generating-vectors, at least the first 2D image.

According to the teachings of the present embodiment there is provided a system for processing data including: a processing system containing one or more processors, the processing system being configured to: provide a fused view 2D image containing information associated with elements of a first 2D image and a second 2D image; and provide generating-vectors associated with the fused 2D image, the generating-vectors indicating operations to be performed on the elements of the fused view 2D image to render the first and second 2D images; and a display module operationally connected to the processing system, the display module being configured to: render, using the fused view 2D image and the generating-vectors, at least the first 2D image; and display the first 2D image.

In an optional embodiment, the display module is further configured to: render, using the fused view 2D image and the generating-vectors, the second 2D image; and display the second 2D image. In another optional embodiment, the display module includes an integrated circuit configured to perform the rendering.

### BRIEF DESCRIPTION OF FIGURES

The embodiment is herein described, by way of example only, with reference to the accompanying drawings, wherein:

FIG. 1, a diagram of a general 3D content and technology chain.

FIG. 2A, a 2D-image of a center view of objects in three dimensions.

FIG. 2B, a simplified depth image.

FIG. 3, a diagram of a typical 2D architecture.

FIG. 4, a diagram of a typical 2D+Depth architecture for the process flow of video on a user device.

FIG. 5 is a diagram of a 3D+F content and technology chain.

FIG. 6, a diagram of a fused 2D view.

FIG. 7, a diagram of rendering using 3D+F.

FIG. 8, a diagram of a 3D+F architecture for the process flow of video on a user device.

FIG. 9, a flowchart of an algorithm for rendering using 3D+F.

FIG. 10, a specific non-limiting example of a generating vectors encoding table.

### DETAILED DESCRIPTION

The principles and operation of the system according to the present embodiment may be better understood with reference to the drawings and the accompanying description. The present embodiment is a system and format for encoding data and three-dimensional rendering. The system facilitates 3D rendering using reduced power requirements compared to conventional techniques, while providing high quality, industry standard image quality. A feature of the current embodiment is the encoding of two source 2D images, in particular a left view and a right view of 3D content into a single 2D image and generating-vectors indicating operations to be performed on the elements of the single 2D image to recover the first and second 2D images. This single 2D image is known as a “fused view” or “cyclopean view,” and the generating-vectors are information corresponding to the encoding, also known as the “fusion information”. This encoding generating-vectors is referred to as 3D+F fusion, and the encoding algorithms, decoding algorithms, format, and architecture are generally referred to as 3D+F, the “F” denoting “fusion information”. Although the generating vectors support general operations (for example filtering and control), in particular, the generating-vectors facilitate decoding the fused view 2D image using only copying and interpolation operations from the fused view to render every element in a left or right view.

Another feature of the current embodiment is facilitating implementation in a display module, in contrast to conventional techniques that are implemented in an application processor. This feature allows minimization of hardware changes to an application processor, to the extent that existing 2D hardware can remain unchanged by provisioning a 2D user device with a new 3D display that implements 3D+F.

In the context of this document, images are generally data structures containing information. References to images can also be interpreted as references to a general data structure, unless otherwise specified. Note that although for clarity in this description, the present embodiment is described with reference to cellular networks and cell phones, this description is only exemplary and the present embodiment can be implemented with variety of similar architectures, or in other applications with similar requirements for 3D imaging.

The system facilitates 3D rendering using reduced power requirements compared to conventional techniques, while providing high quality, industry standard image quality. Power consumption analysis results have shown that for a typical application of HDTV video 3D playback with a 720p resolution on a 4.3-inch display Smartphone, when compared to the power consumption of conventional 2D playback, the power consumption penalty of an implementation of 3D+F is 1%. In contrast, the power consumption penalty of a conventional 2D+Depth format and rendering scheme is 50% (best case).

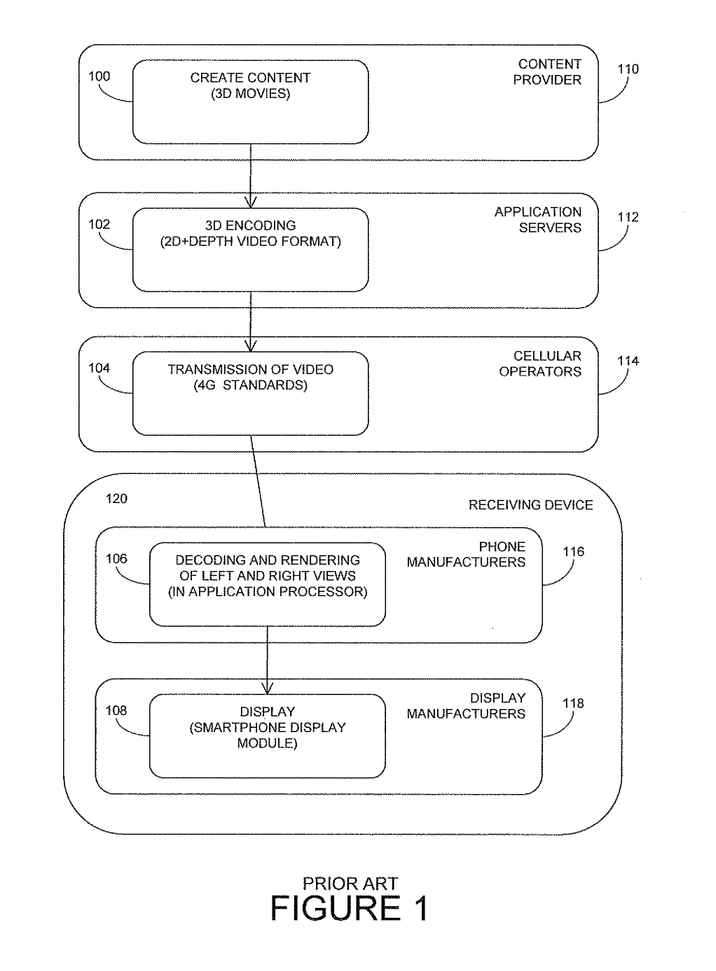

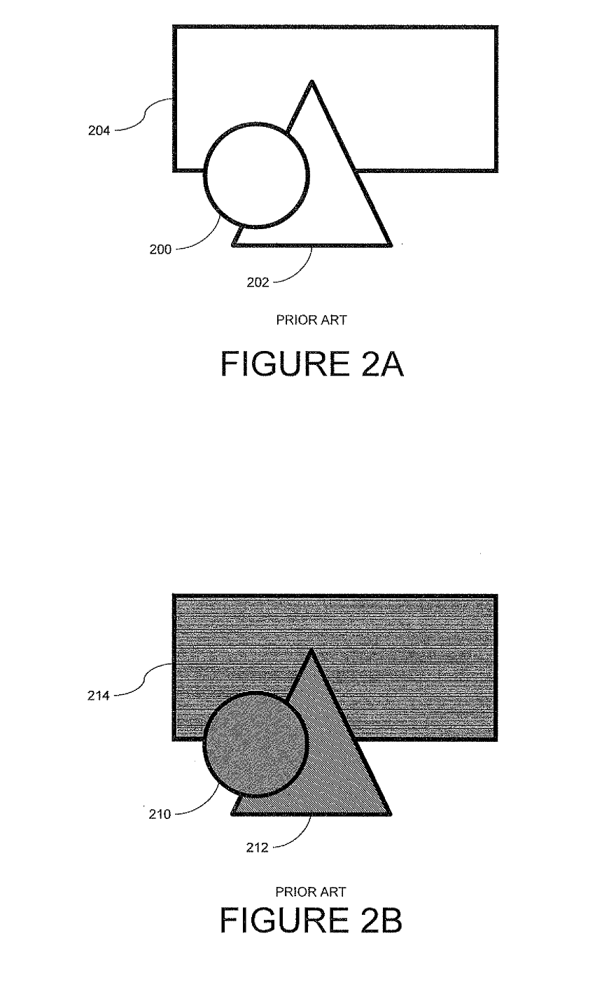

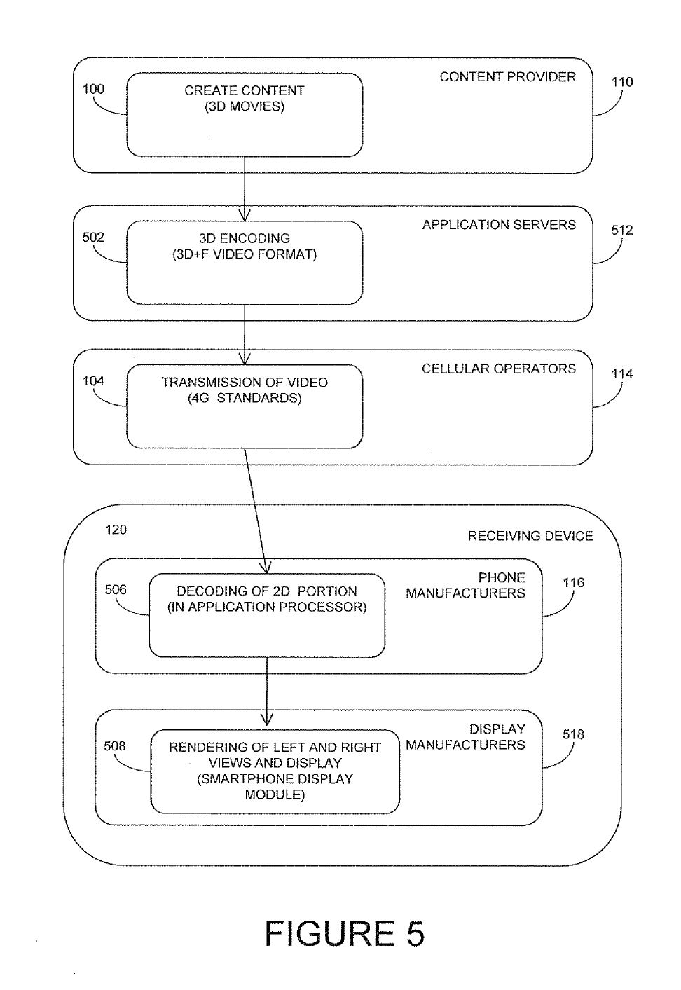

Referring again to the drawings, FIG. 5 is a diagram of a 3D+F content and technology chain, similar to the model described in reference to FIG. 1. In application servers 512, the 3D encoding 502 (of content 100) is encoded into the 3D+F format, in this exemplary case, the 3D+F video format for the encoded information. Application servers typically have access to large power, processing, and bandwidth resources for executing resource intensive and/or complex processing. A feature of 3D+F is delegating process intensive tasks to the server-side (for example, application servers) and simplifying processing on the client-side (for example, user devices). The 3D+F encoded information is similar to conventional 2D encoded information, and can be transmitted (for example using conventional 4G standards 104 by cellular operators 114) to a receiving device 120. 3D+F facilitates high quality, industry standard image quality, being transmitted with bandwidth close to conventional 2D imaging.

Similar to how conventional 2D images are decoded (decompressed) by phone manufacturers 116, the fused view 2D image portion of the 3D+F encoded information is decoded in an application processor 506. In contrast to the 2D+Depth format, rendering is not performed on 3D+F in the application processor 506. The decoded fused view 2D information and the associated generating-vectors are sent to a display module 508 where the 3D+F information is used to render the left and right views and display the views. As described above, displays are typically provided by display manufacturers 518 and integrated into user devices.

A feature of 3D+F is facilitating designing a 3D user device by provisioning a conventional 2D user device with a 3D display module (which implements 3D+F rendering), while allowing the remaining hardware components of the 2D user device to remain unchanged. This has the potential to be a tremendous advantage for user device manufacturers, saving time, cost, and complexity with regards to design, test, integration, conformance, interoperability, and time to market. One impact of 3D+F rendering in a display module is the reduction in power consumption, in contrast to conventional 2D+Depth rendering in an application processor.

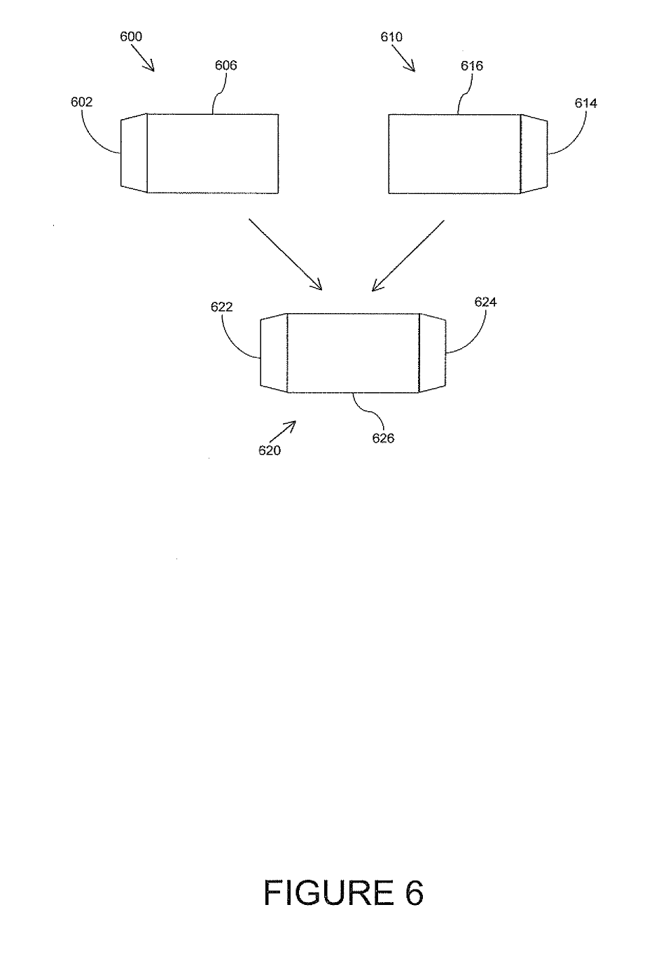

The 3D+F format includes two components: a fused view portion and a generating-vectors portion. Referring to FIG. 6, a diagram of a fused 2D view, a fused view 620 is obtained by correlating a left view 600 and a right view 610 of a scene to derive a fused view, also known as a single cyclopean view, 620, similar to the way the human brain derives one image from two images. In the context of this document, this process is known as fusion. While each of a left and right view contains information only about the respective view, a fused view includes all the information necessary to render efficiently left and right views. In the context of this document, the term scene generally refers to what is being viewed. A scene can include one or more objects or a place that is being viewed. A scene is viewed from a location, referred to as a viewing angle. In the case of stereovision, two views, each from different viewing angles are used. Humans perceive stereovision using one view captured by each eye. Technologically, two image capture devices, for example video cameras, at different locations provide images from two different viewing angles for stereovision.

In a non-limiting example, left view 600 of a scene, in this case a single object, includes the front of the object from the left viewing angle 606 and the left side of the object 602. Right view 610 includes the front of the object from the right viewing angle 616 and the right side of the object 614. The fused view 620 includes information for the left side of the object 622, information for the right side of the object 624, and information for the front of the object 626. Note that while the information for the fused view left side of the object 622 may include only left view information 602, and the information for the fused view right side of the object 624 may include only right view information 614, the information for the front of the object 626 includes information from both left 606 and right 616 front views.

In particular, features of a fused view include:
There are no occluded elements in a fused view. In the context of this document, the term element generally refers to a significant minimum feature of an image. Commonly an element will be a pixel, but depending on the application and/or image content can be a polygon or area. The term pixel is often used in this document for clarity and ease of explanation. Every pixel in a left or right view can be rendered by copying a corresponding pixel (sometimes copying more than once) from a fused view to the correct location in a left or right view.
The processing algorithms necessary to generate the fused view work similarly to how the human brain processes images, therefore eliminating issues such as light and shadowing of pixels.

The type of fused view generated depends on the application. One type of fused view includes more pixels than the original left and right views. This is the case described in reference to FIG. 6. In this case, all the occluded pixels in the left or right views are integrated into the fused view. In this case, if the fused view were to be viewed by a user, the view is a distorted 2D view of the content. Another type of fused view has approximately the same amount of information as either the original left or right views. This fused view can be generated by mixing (interpolating or filtering) a portion of the occluded pixels in the left or right views with the visible pixels in both views. In this case, if the fused view were to be viewed by a user, the view will show a normal 2D view of the content. Note that 3D+F can use either of the above-described types of fused views, or another type of fused view, depending on the application. The encoding algorithm should preferably be designed to optimize the quality of the rendered views. The choice of which portion of the occluded pixels to be mixed with the visible pixels in the two views and the choice of mixing operation can be done in a process of analysis by synthesis. For example, using a process in which the pixels and operations are optimally selected as a function of the rendered image quality that is continuously monitored.

Generally, generating a better quality fused view requires a more complex fusion algorithm that requires more power to execute. Because of the desire to minimize power required on a user device (for example, FIG. 5, receiving device 120), fusion can be implemented on an application server (for example, FIG. 5, 512). Algorithms for performing fusion are known in the art, and are typically done using algorithms of stereo matching. Based on this description one skilled in the art will be able to choose the appropriate fusion algorithm for a specific application and modify the fusion algorithm as necessary to generate the associated generating-vectors for 3D+F.

A second component of the 3D+F format is a generating-vectors portion. The generating-vectors portion includes a multitude of generating-vectors, more simply referred to as the generating-vectors. Two types of generating-vectors are left generating-vectors and right generating-vectors used to generate a left view and right view, respectively.

A first element of a generating vector is a run-length number that is referred to as a generating number (GN). The generating number is used to indicate how many times an operation (defined below) on a pixel in a fused view should be repeated when generating a left or right view. An operation is specified by a generating operation code, as described below.

A second element of a generating vector is a generating operation code (GOC), also simply called “generating operators” or “operations”. A generating operation code indicates what type of operation (for example, a function, or an algorithm) should be performed on the associated pixel(s). Operations can vary depending on the application. In a preferred implementation, at least the following operations are available:
Copy: copy a pixel from a fused view to the view being generated (left or right). If GN is equal to n, the pixel is copied n times.
Occlude: occlude a pixel. For example, do not generate a pixel in the view being generated. If GN is equal to n, do not generate n pixels, meaning that n pixels from the fused view are occluded in the view being generated.
Go to next line: current line is completed, start to generate a new line.
Go to next frame: current frame is completed, start to generate a new frame.

A non-limiting example of additional and optional operations includes Copy-and-Filter: the pixels are copied and then smoothed with the surrounding pixels. This operation could be used in order to improve the imaging quality, although the quality achieved without filtering is generally acceptable.

Note that in general, generating-vectors are not uniformly randomly distributed. This distribution allows the generating-vectors portion to be efficiently coded, for example using Huffmann coding or similarly another type of entropy coding. In addition, generally, the left and right view generating-vectors have a significant degree of correlation due to the similarity of left and right views, hence the left generating-vectors and the right generating-vectors can be jointly coded into one code. The ability of the generating-vectors to be efficiently coded facilitates 3D+F bandwidth requirements being approximately equal to the bandwidth requirements for conventional 2D imaging.

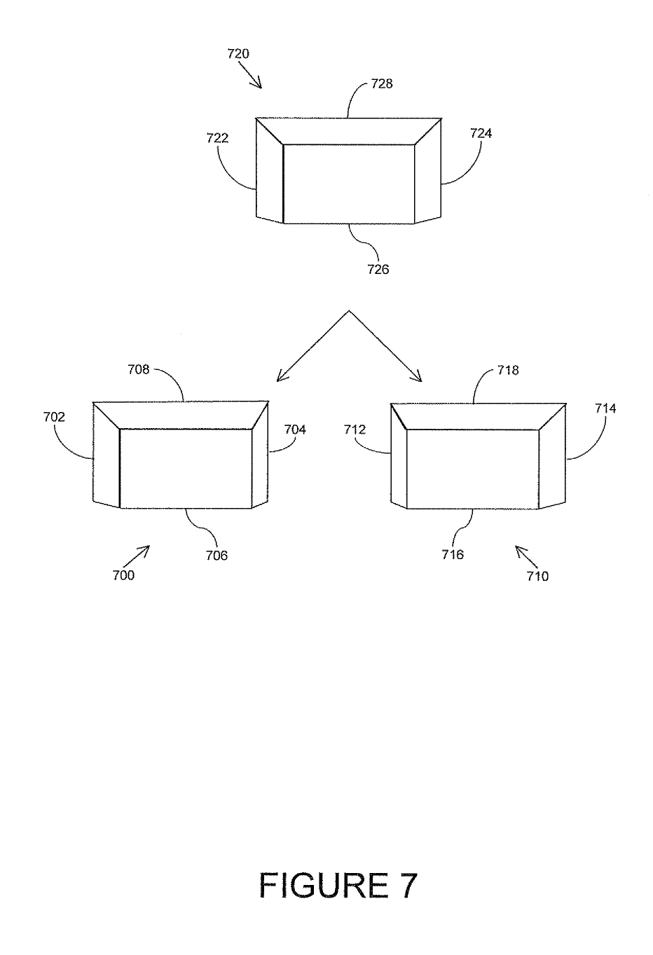

Referring to FIG. 7, a diagram of rendering using 3D+F, a fused 2D view, also known as a single cyclopean view, 720, is used in combination with associated generating-vectors to render a left view 700 and a right view 710 of a scene. Fused view 720, includes information for the left side of the object 722, information for the right side of the object 724, information for the front of the object 726, and information for the top side of the object 728. The generating-vectors include what operations should be performed on which elements of the fused view 720, to render portions of the left view 700 and the right view 710 of the scene. As described above, a feature of 3D+F is that rendering can be implemented using only copying of elements from a fused view, including occlusions, to render left and right views. In a non-limiting example, elements of the fused view of the left side of the object 722 are copied to render the left view of the left side of the object 702. A subset of the elements of the fused view of the left side of the object 722 is copied to render the right view of the left side of the object 712. Similarly, a subset of the elements of the fused view of the right side of the object 724 are copied to render the left view of the right side of the object 704, and elements of the fused view of the right side of the object 724 are copied to render the right view of the right side of the object 714.

A first subset of the elements of the fused view of the top side of the object 728 are copied to render the left view of the top side of the object 708, and a second subset of the elements of the fused view of the top side of the object 728 are copied to render the right view of the top side of the object 718. Similarly, a first subset of the elements of the fused view of the front side of the object 726 are copied to render the left view of the front side of the object 706, and a second subset of the elements of the fused view of the front side of the object 726 are copied to render the right view of the front side of the object 716.

Although a preferred implementation of 3D+F renders the original left and right views from a fused view, 3D+F is not limited to rendering the original left and right views. In some non-limiting examples, 3D+F is used to render views from angles other than the original viewing angles, and render multiple views of a scene. In one implementation, the fusion operation (for example on an application server such as 512) generates more than one set of generating-vectors, where each set of generating vectors generates one or more 2D images of a scene. In another implementation, the generating vectors can be processed (for example on a receiving device such as 120) to generate one or more alternate sets of generating vectors, which are then used to render one or more alternate 2D images.

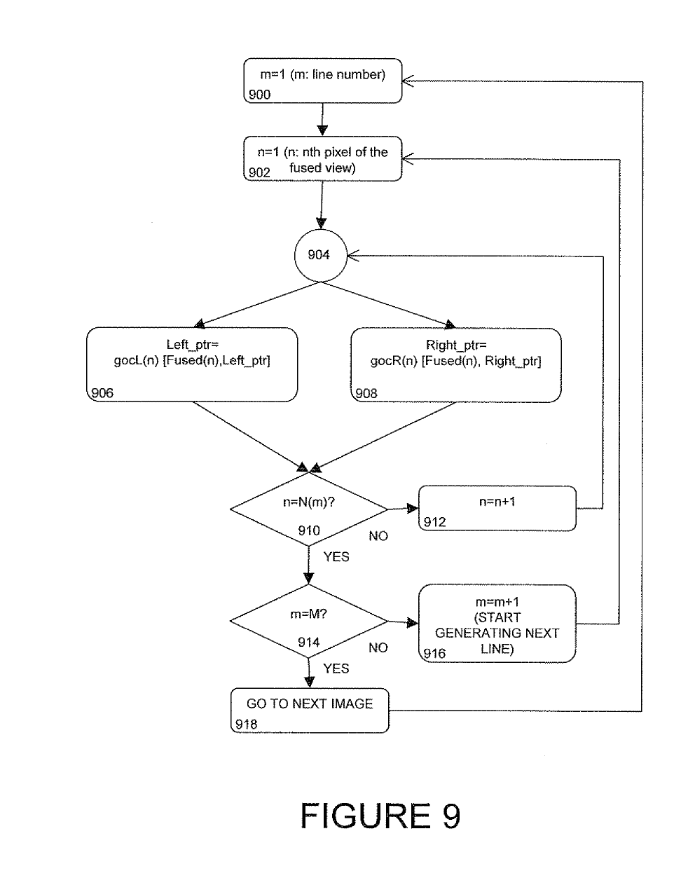

Referring to FIG. 9, a flowchart of an algorithm for rendering using 3D+F, one non-limiting example of rendering left and right views from a fused view in combination with generating-vectors is now described. Generating pixels for a left view and a right view from a fused view is a process that can be done by processing one line at a time from a fused view image, generally known as line-by-line. Assume there are M lines in the fused view. Let m=[1, M]. Then for line m, there are N(m) pixels on the m^{th} line of the fused view. N(m) need not be the same for each line. In block 900, the variable m is set to 1, and in block 902, the variable n is set to 1. Block 904 is for clarity in the diagram. In block 906 gocL(n) is an operation whose inputs are the nth pixel on the fused view (Fused(n)) and a pointer on the left view (Left_ptr), pointing to the last generated pixel. Left_ptr can be updated by the operation. Similarly, in block 908 gocR(n) is an operation whose inputs are the nth pixel on the fused view (Fused(n)) and a pointer on the right view(Right_ptr), pointing to the last generated pixel. Right_ptr can be updated by the operation. In additional to the basic operations described above, examples of operations include, but are not limited to, FIR filters, and IIR filters. In block 910, if not all of the pixels for a line, have been operated on, then in block 912 processing moves to the next pixel and processing continues at block 904. Else, in block 914 if there are still more lines to process, then in block 916 processing moves to the next line. From block 914 if all of the lines in an image have been processed, then in block 918 processing continues with the next image, if applicable.

A more specific non-limiting example of rendering a (left or right) view from a fused view is described as a process that progresses line by line over the elements of the fused view (consistent with the description of FIG. 9). The operations gocR(n) and gocL(n) are identified from the generating vectors as follows:

Let GV(i) be the decoded generating vectors (GV) of a given line, for example, line m, m=1, . . . M, for a given view (a similar description applies to both views).

The generating vectors can be written in terms of components, for example, the operation (op) and generating number (gn):

```
op = GV(i).goc (1)
gn = GV(i).GN (2)
for (i=1...k) //k denotes the number of generating vectors on the line
    op = GV(i).goc (1)
      gn = GV(i).GN (2
    for (k=1,...gn)
          DO the inner loop of FIGURE 9 with goc = op
    end // for (k=1,...gn)
end // for (i=1...k)
```

While the above examples have been described for clarity with regard to operations on single pixels, as described elsewhere, 3D+F supports operations on multiple elements as well as blocks of elements. While the above-described algorithm may be a preferred implementation, based on this description one skilled in the art will be able to implement an algorithm that is appropriate for a specific application.

Some non-limiting examples of operations that can be used for rendering are detailed in the following pseudo-code:

CopyP: copy pixel to pixel
Call: Pixel_ptr=CopyP [FusedInput(n), Pixel_ptr]
Inputs:

FusedInput(n): n^{th} pixel of fused view (on m^{th} line)
Pixel_ptr: pointer on left or right view (last generated)

Process:

copy FusedInput(n) to Pixel_ptr+1

Output:

updated Pixel_ptr=Pixel_ptr+1

CopyPtoBlock: copy pixel to block of pixels
Call: Pixel_ptr=CopyPtoBlock [FusedInput(n), Pixel_ptr,
BlockLength]
Inputs:

FusedInput(n): n^{th} pixel of fused view (on m^{th} line)
Pixel_ptr: pointer on left or right view (last generated)
BlockLength: block length

Process:

copy FusedInput(n) to Pixel_ptr+1, Pixel_ptr+2,

...Pixel_ptr+BlockLength
Output:

updated Pixel_ptr=Pixel_ptr+BlockLength

OccludeP: occlude pixel
Call: OccludeP [FusedInput(n)]
Inputs:

FusedInput(n): n^{th} pixel of fused view (on m^{th} line)

Process:

no operation

Output:

none

WeightCopyP: copy weighted pixel to pixel
Call: WeightCopyP [FusedInput(n), Pixel_ptr, a]
Inputs:

FusedInput(n): n^{th} pixel of fused view (on m^{th} line)
Pixel_ptr: pointer on left or right view (last generated)
a: weight

Process:

copy a*FusedInput(n) to Pixel_ptr+1

Output:

updated Pixel_ptr=Pixel_ptr+1

Interpolate and copy: interpolate two pixels of the fused

view and copy

Call: InterpolateAndCopy [FusedInput(n), Pixel_ptr, a]
Inputs:

FusedInput(n): n^{th} pixel of fused view (on m^{th} line)
Pixel_ptr: pointer on left or right view (last generated)
a: weight

Process:

copy a*FusedInput(n) + (1−a)*FusedInput(n+1) to to
Pixel_ptr+1

Output:

updated Pixel_ptr=Pixel_ptr+1

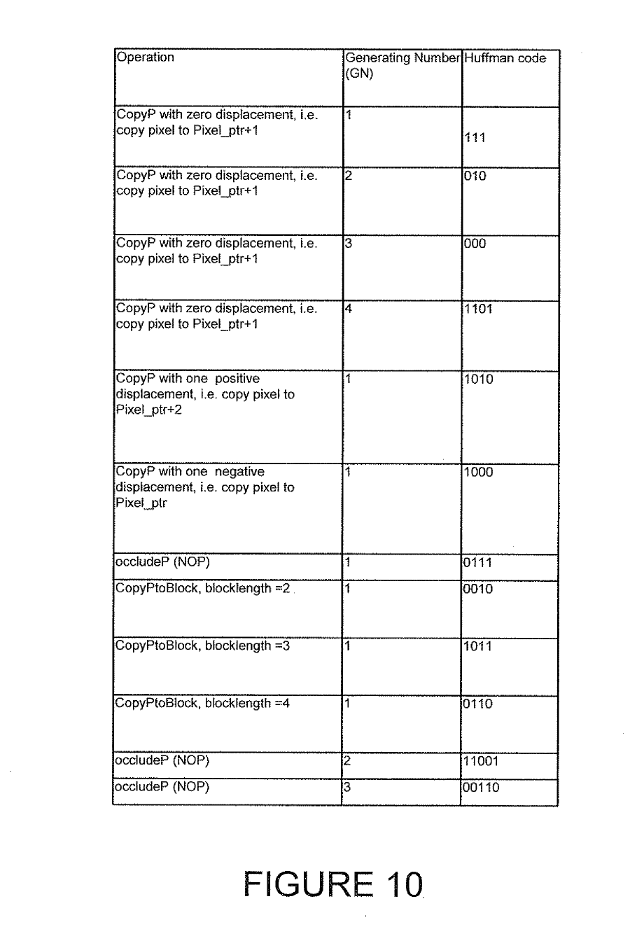

Referring to FIG. 10, a specific non-limiting example of a generating vectors encoding table is now described. A preferable implementation is to code generating vectors with entropy coding, because of the high redundancy of the generating vectors. The redundancy comes from the fact that typically neighboring pixels in an image often have same or similar distances, and therefore the disparities between the fused view and the rendered view are the same or similar for neighboring pixels. An example of entropy coding is Huffman coding. In FIG. 10, using the list of operations described above, Huffman coding codes the most frequent operations with fewer bits.

Note that, as previously described, a variety of implementations of generating vectors are possible, and the current example is one non-limiting example based on the logic of the code. It is foreseen that more optimal codes for generating vectors can be developed. One option for generating codes includes using different generating vector encoding tables based on content, preferably optimized for the image content. In another optional implementation, the tables can be configured during the process, for example at the start of video playback.

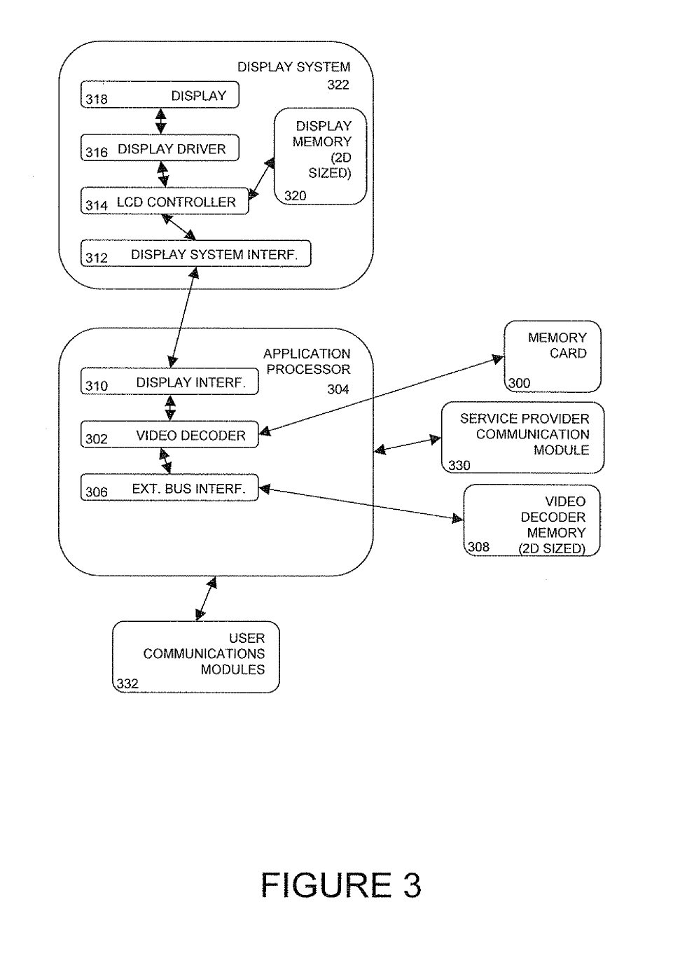

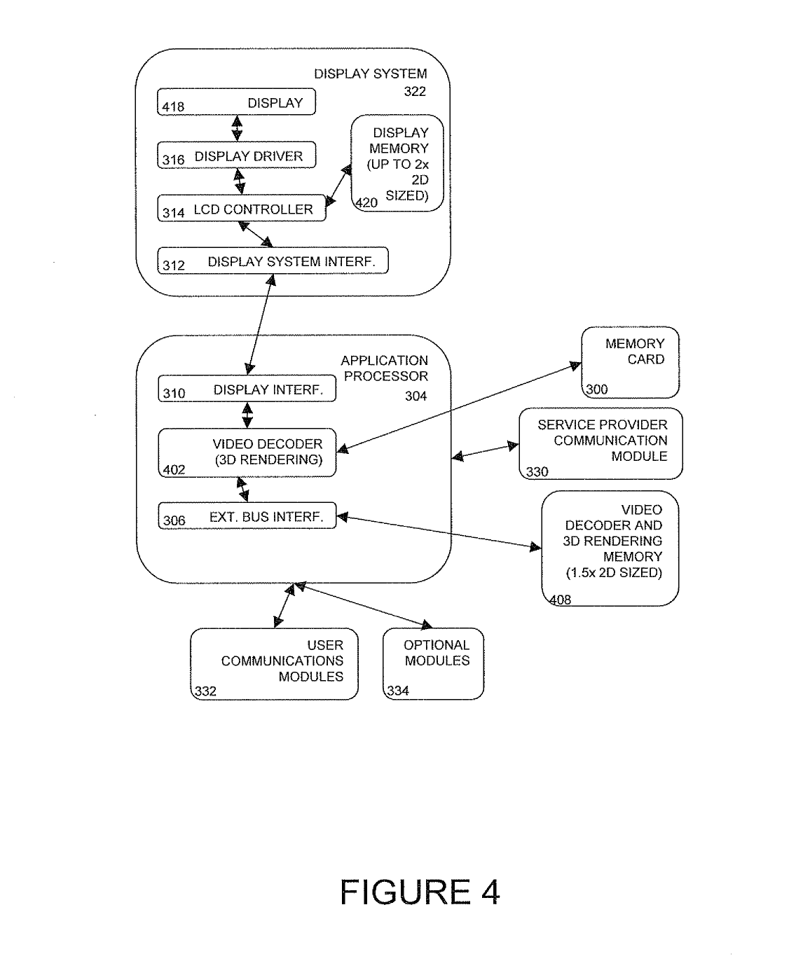

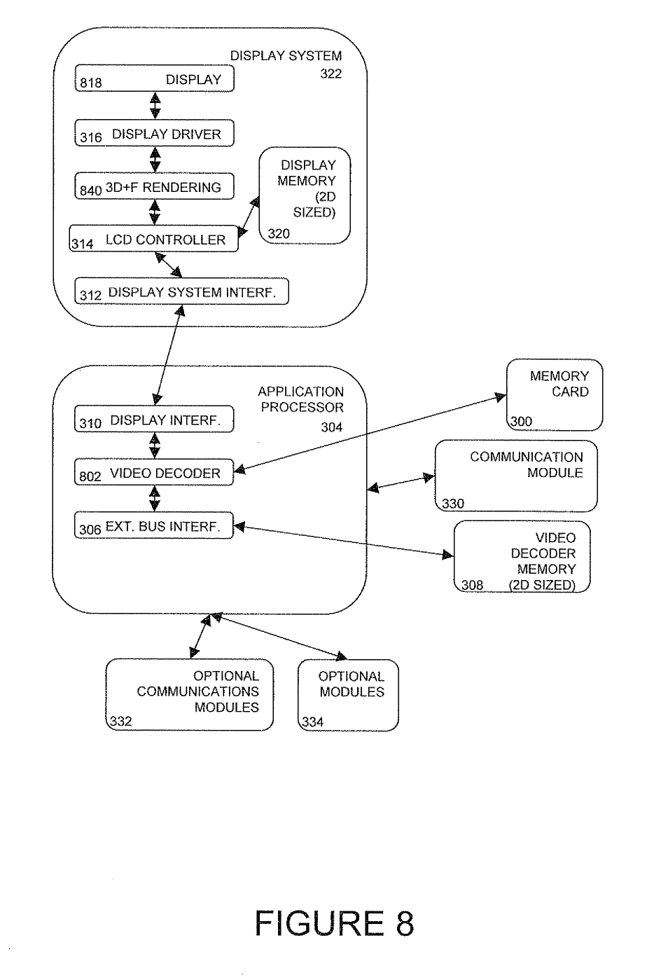

Referring to FIG. 8, a diagram of a 3D+F architecture for the process flow of video on a user device, a cell phone architecture is again used as an example. Generally, the processing flow for 3D+F is similar to the processing flow for 2D described in reference to FIG. 3. As described above, conventional application processor 304 hardware and memory (both video decoder memory 308 and in the display memory 320) can be used to implement 3D+F. Significant architecture differences include an additional 3D+F rendering module 840 in the display system 322, and a 3D display 818.

Encoded information, in this case compressed video packets and associated 3D+F generating-vectors, are read from a memory card 300 by a video decoder 802 in an application processor 304 and sent via an external bus interface 306 to video decoder memory 308. Similar to conventional 2D imaging, 3D+F contains only one stream of 2D images to be decoded, so the video decoder memory 308 needs to be about the same size for 2D and 3D+F. The encoded information (in this case video packets) is decoded by video decoder 802 to generate decoded frames that are sent to a display interface 310. In a case where the video packets are H.264 format, processing is as described above.

Decoded frames and associated 3D+F information (generating-vectors) are sent from the display interface 310 in the application processor 304 via a display system interface 312 in the display system 322 to the display controller 314 (in this case an. LCD controller), which stores the decoded frames in a display memory 320. Display system 322 implements the rendering of left and right views and display described in reference to FIG. 5, 508. Similar to conventional 2D imaging, 3D+F contains only one decoded stream of 2D images (frames), so the display memory 320 needs to be about the same size for 2D and 3D+F. From display memory 320, the LCD controller 314 sends the decoded frames and associated generating-vectors to a 3D+F rendering module 840. In a case where the generating-vectors have been compressed, decompression can be implemented in the display system 322, preferably in the 3D+F rendering module 840. Decompressing the generating-vectors in the 3D+F rendering module 840 further facilitates implementation of 3D+F on a conventional 2D architecture, thus limiting required hardware and software changes. As described above, the 2D images are used with the generating-vectors to render a left view and a right view, which are sent via a display driver 316 to a 3D display 818. 3D display 818 is configured as appropriate for the specific device and application to present the decoded frames to a user, allowing the user to view the desired content in stereovision.

The various modules, processes, and components of these embodiments can be implemented as hardware, firmware, software, or combinations thereof, as is known in the art. One preferred implementation of a 3D+F rendering module 840 is as an integrated circuit (IC) chip. In another preferred implementation, the 3D+F rendering module 840 is implemented as an IC component on a chip that provides other display system 322 functions. In another preferred implementation, the underlying VLSI (very large scale integration) circuit implementation is a simple one-dimensional (1D) copy machine. ID-copy machines are known in the art, in contrast to 2D+Depth that requires special logic.

It will be appreciated that the above descriptions are intended only to serve as examples, and that many other embodiments are possible within the scope of the present invention as defined in the appended claims.

What is claimed is:

1. A method for storing data comprising the steps of:
(a) receiving a first set of data;
(b) receiving a second set of data;
(c) generating a fused set of data and associated generating-vectors, by combining the first and second sets of data, such that said fused set of data contains information associated with elements of the first and second sets of data, and said generating-vectors indicate operations to be performed on the elements of said fused set of data to recover the first and second sets of data; and
(d) storing said fused set of data and said generating-vectors in association with each other.

2. A method for encoding data comprising the steps of:
(a) receiving a first two-dimensional (2D) image of a scene from a first viewing angle;
(b) receiving a second 2D image of said scene from a second viewing angle;
(c) generating a fused view 2D image and associated generating-vectors, by combining the first and second 2D images such that said fused view 2D image contains information associated with elements of the first and second 2D images, and said generating-vectors indicate operations to be performed on the elements of said fused view 2D image to recover the first and second 2D images; and
(d) storing said fused view 2D image and said generating-vectors in association with each other.

3. A method for decoding data comprising the steps of:
(a) providing a fused view 2D image containing information associated with elements of a first 2D image and a second 2D image;
(b) providing generating-vectors associated with said fused 2D image, said generating-vectors indicating operations to be performed on the elements of said fused view 2D image to render the first and second 2D images; and
(c) rendering, using said fused view 2D image and said generating-vectors, at least said first 2D image.

4. The method of claim 3 further comprising the step of rendering said second 2D image.

5. A system for storing data comprising:
(a) a processing system containing one or more processors, said processing system being configured to:
(i) receive a first set of data;
(ii) receive a second set of data;
(iii) generate a fused set of data and associated generating-vectors, by combining the first and second sets of data, such that said fused set of data contains information associated with elements of the first and second sets of data, and said generating-vectors indicate operations to be performed on the elements of said fused set of data to recover the first and second sets of data; and
(b) a storage module configured to store said fused set of data and said generating-vectors in association with each other.

6. The system of claim 5 wherein the data is in Hb .264 format.

7. The system of claim 5 wherein the data is in MPEG4 format.

8. A system for encoding data comprising:
(a) a processing system containing one or more processors, said processing system being configured to:
(i) receive a first two-dimensional (2D) image of a scene from a first viewing angle;
(ii) receive a second 2D image of said scene from a second viewing angle;
(iii) generate a fused view 2D image and associated generating-vectors, by combining the first and second 2D images such that said fused view 2D image contains information associated with elements of the first and second 2D images, and said generating-vectors indicate operations to be performed on the elements of said fused view 2D image to recover the first and second 2D images; and
(b) a storage module configured to store said fused view 2D image and said generating-vectors in association with each other.

9. A system for decoding data comprising:
(a) a processing system containing one or more processors, said processing system being configured to:
(i) provide a fused view 2D image containing information associated with elements of a first 2D image and a second 2D image;
(ii) provide generating-vectors associated with said fused 2D image, said generating-vectors indicating operations to be performed on the elements of said fused view 2D image to render the first and second 2D images; and
(iii) render, using said fused view 2D image and said generating-vectors, at least said first 2D image.

10. A system for processing data comprising:
(a) a processing system containing one or more processors, said processing system being configured to:
(i) provide a fused view 2D image containing information associated with elements of a first 2D image and a second 2D image; and
(ii) provide generating-vectors associated with said fused 2D image, said generating-vectors indicating operations to be performed on the elements of said fused view 2D image to render the first and second 2D images; and
(b) a display module operationally connected to said processing system, said display module being configured to:
(i) render, using said fused view 2D image and said generating-vectors, at least said first 2D image; and
(ii) display the first 2D image.

11. The system of claim 10 wherein said display module is further configured to:
(a) render, using said fused view 2D image and said generating-vectors, said second 2D image; and
(b) display the second 2D image.

12. The system of claim 10 wherein said display module includes an integrated circuit configured to perform the rendering.

13. The system of claim 10 wherein said display module includes an integrated circuit configured with a one-dimensional copy machine to render using said fused view 2D image and said generating-vectors, said first 2D image.
